(19) United States
(12) Patent Application Publication
(10) Pub. No.: US 2026/0211076 A1
(43) Pub. Date: Jul. 23, 2026

(54) METHODS AND APPARATUS FOR INDEPENDENT NON-TERRESTRIAL AIR TRAFFIC SURVEILLANCE

(71) Applicant: European Space Agency, Paris (FR)

(72) Inventors: Nader Alagha, Noordwijk (NL); Giovanni Garofalo, Noordwijk (NL); Antonio Garutti, Noordwijk (NL)

(21) Appl. No.: 19/140,242

(22) PCT Filed: Dec. 20, 2022
(86) PCT No.: PCT/EP2022/087046

§ 371 Date: Jun. 17, 2025

(51) Int. Cl. G01S 5/02; G01S 5/06; G08G 5/72

(52) U.S. Cl. CPC G01S 5/02213; G01S 5/0246; G01S 5/0249; G01S 5/06; G08G 5/72; G01S 2205/03

(57) ABSTRACT

A method of air-based or space-based air surveillance includes determining a position of an aircraft. The aircraft repeatedly transmits a radio signal of predetermined format. The method includes, at each of at least four airborne or spaceborne receivers, receiving the radio signal and determining a time of arrival or a Doppler frequency shift of the received radio signal at the respective receiver. Determining the time of arrival or the Doppler frequency shift of the received radio signal comprises detecting a static portion of the received radio signal. The method further includes determining the position of the aircraft based on the determined at least four times of arrival or the determined at least four Doppler frequency shifts. Further disclosed is a corresponding system for air-based or space-based air surveillance.

### BACKGROUND

### Technical Field

The present disclosure relates to techniques for space-based air traffic surveillance. The disclosure particularly relates to such techniques that use MODES-S signals and/or that are GNSS-independent.

### Description of the Related Art

Space-based detection of MODE-S extended squitter signals was demonstrated using the PROBA-V satellite as reported in reference document [1]. The Automatic Dependent Surveillance-Broadcast (ADS-B) payload of these signals collects a messages containing the self-position reporting of the aircraft that relies on Global Navigation Satellite System (GNSS; e.g., GPS, Galileo, GLONASS, Beidou/Compass) receivers onboard the aircraft. The self-reported position of the aircraft as contained in the ADS-B payload can be used for tracking the aircraft. Further, the self-reported position of the ADS-B payload may be validated using two or more satellites, as described in reference documents [2], [3], and [4].

Conventional techniques thus rely on the self-reported aircraft position included in the ADS-B payload of MODE-S extended squitter signals. The MODE-S signal format may be defined according to the ICAO specifications as given, for example, in reference document [5]. This self-reported position however is subject to technical error or failure at the aircraft and depends on proper operation of a GNSS. Moreover, these conventional techniques are not secure against intentional reporting of false positions by the aircraft.

Thus, there is a need for improved techniques for air surveillance. There is particular need for such techniques that are not affected by errors or failure of position determination at the aircraft, or by intentional manipulation of self-reported aircraft positions. There is further need for such techniques that are GNSS-independent.

### BRIEF SUMMARY

In view of some or all of these needs, the present disclosure proposes a method of air-based or space-based (e.g., satellite-based) air surveillance and a system for air-based or space-based (e.g., satellite-based) air surveillance, having the features of the respective independent claims.

An aspect of the disclosure relates to a method of air-based or space-based (e.g., satellite-based) air (traffic) surveillance for determining a position of an aircraft. The method may be generally referred to as a method of non-terrestrial air (traffic) surveillance. The aircraft may be airborne. Further, the aircraft may repeatedly transmit a radio signal of predetermined format. The method may include, at each of at least four airborne or spaceborne receivers (e.g., receiver platforms), receiving the radio signal, and determining a time of arrival or a frequency shift (e.g., Doppler frequency shift) of the received radio signal at the respective satellite. The receivers (receiver platforms) may be satellites in earth orbit or high altitude platforms, for example. The time of arrival may be determined for each of the at least four receivers, or the (Doppler) frequency shift may be determined for each of the at least four receivers. The positions of the receivers (e.g., satellites) at any given point in time (or at least at relevant points in time) may be known or derivable. Determining the time of arrival or the (Doppler) frequency shift of the received radio signal may include detecting a static portion of the received radio signal. The static portion of the radio signal may be static in that it does not change from one instance of the radio signal transmitted by the aircraft to the next. The method may further include determining the position of the aircraft based on the determined at least four times of arrival or the determined at least four (Doppler) frequency shifts.

With this configuration, the proposed method does not need to rely on GNSS or self-position reporting of the aircraft (e.g., within ADS-B content of the received radio signal). Instead, it can use at least part of the known (e.g., static) content of the radio signal (e.g., MODE-S radio signal) for enhancing signal detection and parameter estimation. In particular a unique aircraft identifier (possibly together with parity bits) is readily available for this purpose in all relevant radio signals. Compared to conventional techniques, the method in this disclosure can thus leverage on the known signal content to detect the presence of the radio signal and enhance the probability and accuracy of detection, followed by more accurate estimation of the time of arrival and carrier frequency offset. Moreover, the proposed method is independent of the aircraft's self-reported position (e.g., ADS-B self-position reporting), thereby improving resilience in the presence of inadvertently or intentionally false self-position reports. Since the proposed method can be employed in a passive listening mode, it does not require active interrogation of the aircraft, thereby reducing or avoiding impact on pre-established systems of air traffic surveillance. In particular, the proposed method does not require any modifications of the aero segment and is therefore compatible with any (upwards-pointing or downwards-pointing) aircraft transmitters currently in use. In consequence, the proposed method provides a space-based concept as a basis for achieving resilient air traffic surveillance in a cost-efficient way.

In some embodiments, the static portion of the radio signal may include a unique identifier of the aircraft. The unique identifier may be the aircraft's 24-bit International Civil Aviation Organization (ICAO) identifier, for example. Since such unique identifier can be expected to be included in any radio signals emitted by the aircraft (especially MODE-S signals), this allows to efficiently leverage on the known signal content.

In some embodiments, the static portion may further include a fixed preamble of the radio signal of predetermined format. Thereby, the length of the static portion that can be used for signal detection and parameter estimation is extended, and accuracy and reliability of signal detection and parameter estimation can be improved.

In some embodiments, the radio signal of predefined format may be a MODE-S signal. The MODE-S signal format may be defined according to the ICAO specifications as given, for example, in reference document [5].

In some embodiments, the static portion of the MODE-S signal may include at least one of a known preamble sequence, a known downlink format, a known ICAO identifier, and a known transponder capability. In the particular case of a short squitter message for a specific aircraft, all of the MODE-S data content may be known at the receiver. In general, the static portion may include any parts of the underlying message that are static and/or known at the receiver.

In some embodiments, the static portion of the MODE-S signal may include (at least) bit positions 9 through 32 of the MODE-S signal. Therein, each bit position may correspond to a respective 1 us time slot. The radio signal may include an 8 us (fixed) preamble preceding a number of 1 us time slots, each corresponding to a respective bit position. For MODE-S signals, the 24-bit ICAO identifier will always be located after the preamble.

In some embodiments, information on the unique identifier of the aircraft may be received by the at least four receivers as an input or may be determined from analysis of previously received instances of the radio signal. The former alternative may relate to the case that the aircraft to be surveilled is known in advance. In this case a correlator may be used to detect the specific 24-bit combination, for example triggered by detection of the preamble. The latter alternative may relate to the case that the surveillance system initially determines unique identifiers of aircraft that are within a certain area of coverage.

In some embodiments, detecting the static portion of the received radio signal by one or more of the at least four receivers may include applying a correlator for the static portion to the received radio signal. Noting that the static portion is known, the correlator may be pre-established. Further, each of the at least four receivers may detect the static portion by applying the correlator.

In some embodiments, the correlator may be applied in response to detecting a predetermined preamble of the radio signal. That is, when receiving the radio signal and detecting the preamble, the correlator may be applied to a certain time window subsequent to the detected preamble.

In some embodiments, detecting the static portion of the received radio signal by one or more of the at least four receivers may include decoding the static portion of the received radio signal. This may be the case if the unique identifier is not a priory known, for example.

In some embodiments, the method may further include establishing a common time reference (e.g., common system time reference) for the at least four receivers (e.g., satellites). Receiver clocks (e.g., satellite clocks) may either be synchronized to the common time reference (e.g., common time frame, common reference time), or the common time reference may be used as basis for determining receiver clocks using known or estimated clock drifts. Further, it is understood that generating a time-stamped indication of the position of the aircraft in a certain external time reference may require knowledge of a relationship between the common time frame of the at least four receivers and the external time reference.

In some embodiments, the common time reference for the at least four receivers may be independent from a time reference of a transmitter of the radio signal. That is, the common time reference (reference frame) may be an independent time reference. For example, the common time reference may be different from the time reference of the transmitter of the radio signal (or of the aircraft).

In some embodiments, the common time reference for the at least four receivers may be independent from a GNSS time reference. That is, the common time reference (reference frame) may be GNSS independent. Here, GNSS may refer to one of GPS, Galileo, GLONASS, and Beidou/Compass, for example. Accordingly, the common time reference may be different from the GNSS time reference. This improves resilience of the proposed method with respect to error-related or intentional inaccuracies of the GNSS service.

In some embodiments, the position of the aircraft may be determined based on the determined at least four times of arrival by using multilateration (multilateration techniques). Alternatively, the position of the aircraft may be determined based on the determined at least four (Doppler) frequency shifts by using multilateration (multilateration techniques).

In some embodiments, the position of the aircraft may be determined further based on known positions of the at least four receivers at respective times of arrival.

In some embodiments, the method may further include, by each of the at least four receivers: generating a data set including the determined time of arrival or (Doppler) frequency shift in association with the unique identifier of the aircraft. These data sets may be collected at a given location for the determination of the position of the aircraft, together with, for example, the satellites' orbit positions at respective times of arrival.

In some embodiments, the aircraft may periodically or pseudo-periodically transmit the radio signal of predetermined format. Here pseudo-periodically may mean that the actual transmission times are randomized around periodic target transmission times, or randomized within a sequence of transmission time slots.

In some embodiments, the aircraft may transmit the radio signal of predetermined format regardless of interrogation. It is thus understood that the proposed method does not include interrogating the aircraft. For example, the radio signal of predetermined format may be a squitter signal in broadcast mode, without any need of interrogation. It is also understood that the proposed method may use radio signals that are transmitted by the aircraft in response to interrogation (e.g., by third parties) that is independent from the method. Thereby, minimum impact on the aero segment, for example in terms of required modifications, can be ensured.

Another aspect of the disclosure relates to a system for air-based or space-based (e.g., satellite-based) air (traffic) surveillance for determining a position of an aircraft. The system may be generally referred to as a system for non-terrestrial air (traffic) surveillance. The aircraft may repeatedly transmit a radio signal of predetermined format. The system may include at least four airborne or spaceborne receivers (receiver platforms; e.g., satellites in earth orbit or high altitude platforms). Each receiver may be configured for receiving the radio signal and determining a time of arrival or a frequency shift (e.g., Doppler frequency shift) of the received radio signal at the respective receiver. Determining the time of arrival or the (Doppler) frequency shift of the received radio signal may include detecting a static portion of the received radio signal. The system may further include a processing unit for determining the position of the aircraft based on the determined at least four times of arrival or the determined at least four (Doppler) frequency shifts. The processing unit may be provided at one of the at least four receivers (e.g., satellites) or separate from the at least four receivers. For example, the processing unit may be provided at the ground segment. Optionally, the processing unit may be responsible for determining the times of arrival, if raw versions of the received radio signals are transmitted from the receivers to the processing unit.

In some embodiments, the static portion of the radio signal may include a unique identifier of the aircraft.

In some embodiments, the static portion may further include a fixed preamble of the radio signal of predetermined format.

In some embodiments, the radio signal of predefined format may be a MODE-S signal.

In some embodiments the static portion of the MODE-S signal may include at least one of a known preamble sequency, a known downlink format, a known ICAO identifier, and a known transponder capability.

In some embodiments, the static portion of the MODE-S signal may include bit positions 9 through 32 of the MODE-S signal.

In some embodiments, information on the unique identifier of the aircraft may be received by the at least four receivers as an input or may be determined from analysis of previously received instances of the radio signal.

In some embodiments, detecting the static portion of the received radio signal by one or more of the at least four receivers may include applying a correlator for the static portion to the received radio signal.

In some embodiments, the correlator may be applied in response to detecting a predetermined preamble of the radio signal.

In some embodiments, detecting the static portion of the received radio signal by one or more of the at least four receivers may include decoding the static portion of the received radio signal.

In some embodiments, a common time reference may be established for the at least four receivers.

In some embodiments, the common time reference for the at least four receivers may be independent from a time reference of a transmitter of the radio signal.

In some embodiments, the common time reference for the at least four receivers may be independent from a GNSS time reference.

In some embodiments, the position of the aircraft may be determined based on the determined at least four times of arrival by using multilateration. Alternatively, the position of the aircraft may be determined based on the determined at least four (Doppler) frequency shifts by using multilateration.

In some embodiments, the position of the aircraft may be determined further based on known positions of the at least four receivers (e.g., satellites) at respective times of arrival.

In some embodiments, each of the at least four receivers may be further configured for generating a data set including the determined time of arrival or (Doppler) frequency shift in association with the unique identifier of the aircraft.

In some embodiments, the aircraft may periodically transmit the radio signal of predetermined format.

In some embodiments, the aircraft may transmit the radio signal of predetermined format regardless of interrogation.

It will be appreciated that apparatus features and method steps may be interchanged in many ways. In particular, the details of the disclosed apparatus or system (e.g., satellite or constellation of satellites) can be realized by the corresponding method of operating the apparatus/system or parts thereof, and vice versa, as the skilled person will appreciate. Moreover, any of the above statements made with respect to the apparatus/system are understood to likewise apply to the corresponding method, and vice versa.

### BRIEF DESCRIPTION OF THE SEVERAL VIEWS OF THE DRAWINGS

Example embodiments of the disclosure are explained below with reference to the accompanying drawings, wherein:

FIG. 1 schematically illustrates an example of a system for satellite-based air surveillance according to embodiments of the disclosure,

FIG. 2 is a flowchart illustrating an example of a method of satellite-based air surveillance according to embodiments of the disclosure,

FIG. 3 schematically illustrates an example of the content of a MODE-S signal, and

FIG. 4 to FIG. 6 are diagrams illustrating examples of performance results of techniques according to embodiments of the disclosure.

### DETAILED DESCRIPTION

### Introduction

While reference throughout the disclosure is frequently made to MODE-S and MODE-S(extended) squitter radio signals, it is understood that the present disclosure likewise applies to other radio signals, provided that they satisfy the minimum requirements of the proposed techniques (e.g., the requirement of having a static portion).

Moreover, while reference throughout the disclosure is frequently made to satellites as receivers of the radio signals, it is understood that the present disclosure likewise applies to other airborne or spaceborne receivers (receiver platforms), such as high-altitude platforms. The present disclosure further relates to techniques employing combinations of different receivers (receiver platforms), including systems comprising satellites and high-altitude platforms. Unless indicated otherwise, it is understood that statements made with regard to satellites likewise apply to other receiver platforms, such as high-altitude platforms.

Broadly speaking, the present disclosure provides techniques (e.g., methods and systems) for air-based or space-based (or in general, non-terrestrial) air traffic surveillance, completely independent of GNSS and aircraft self-position reporting. The GNSS-independence distinguishes the proposed techniques from techniques based on the Automatic Dependent Surveillance-Broadcast (ADS-B), which reports the aircraft position based on the GNSS information. The proposed technique instead uses radio signals (e.g., MODE-S squitter radio signals) that are recurrently transmitted by the aircraft; each of these signals contains a static aircraft identifier (e.g., 24-bit aircraft unique identifier known as ICAO aircraft address) and other known bits (such as parity bits for the static address, for example). The static content of the radio signals (e.g., MODE-S signals) is particularly important as it allows receivers (e.g., satellite receivers, high-altitude platform receivers) to significantly improve the signal detection as well as timing and carrier frequency estimation of the incoming signal, hence improving the accuracy of post-processing algorithms for geo-locating the aircraft.

Based thereon, the aircraft position can be computed in real-time by applying one of several known techniques, such as multilateration techniques, relying on (differential) Time Difference of Arrival (TDOA) or (differential) Frequency Difference of Arrival (FDOA). Multiple receivers (e.g., satellites) will receive each aircraft's MODES-S squitter (broadcasting) signals either with some time delay or with relevant frequency difference due to the Doppler effect, proportional to the distance of the aircraft from each receiver, making it possible to calculate the aircraft position geometrically, simply based on the differences in the times of arrival or the frequency (Doppler) shift of the signals received by multiple receivers. This may be done using multilateration techniques, as described in more detail below.

Notably, the proposed techniques only rely on passive methods of signal observation and do not require any external intervention or interrogation of the aircraft. Hence there is no need to change the existing MODE-S transmitting signal format in order to deploy the proposed techniques. This is of paramount importance for the operational utilization of the concept as it does not require any additional equipment on board of the aircraft or any change in the operation procedures.

The position of each receiver (e.g., satellite) at the time of arrival of the aircraft's signals is assumed to be known, for example through orbit determination techniques, orbit propagation, ground based ranging, or other solutions. All of these solutions may be GNSS-independent. Thus, at least some implementations of the present disclosure relate to GNSS-independent air surveillance.

The times of arrival, or equivalently, the reference clocks of satellites that observe the same MODE-S signals are expected to be synchronized to an independent (e.g., non-GNSS related) system clock (e.g., high accuracy system clock). This can involve that the reference clocks are actually in synchronization, or that clock drifts, etc. of respective reference clocks with respect to a common time reference are known or can be estimated. Techniques for GNSS-independent clock synchronization are known in the art. One non-limiting example is given in reference document [6].

It is understood that the proposed techniques are entirely independent of the chosen means for clock synchronization. This allows to use a GNSS-independent system clock to thereby increase overall independence and resilience, but does not bar from using a GNSS-dependent system clock if it is readily available.

The FDOA or TDOA techniques may rely on the time or frequency synchronization of the satellites with the independent system time reference to determine the aircraft position. Basically the reference system against which the aircraft position is calculated may be based on an independent (from GNSS) reference clock system which is distributed to all satellites in the constellation used for the measurement, as described above.

Accordingly, techniques according to the present disclosure involve establishing a common time reference (e.g., common system time reference) for the involved satellites (e.g., at least four satellites). As noted above, the satellite clocks (reference clocks of the satellites) can either be synchronized to the common system time reference (e.g., common time frame, common reference time), or the common system time reference can be used as basis for determining satellite clocks using known or estimated clock drifts. Preferably, the common system time reference for the at least four satellites is independent (e.g., different) from a time reference of a transmitter of the radio signal (or the aircraft, for that matter), and also independent (e.g., different) from a GNSS time reference. That is, the common system time reference (reference frame) may be an independent (in particular, GNSS-independent) time reference.

It is noted in this regard that while the satellites' clocks may be GNSS-independent, generating a time-stamped indication of the position of the aircraft in a certain external time reference (e.g., external users time reference) may require knowledge of a relationship between the common time frame of the at least four satellites and the external time reference in some cases.

In order to determine the position of the aircraft, at least four independent observations (e.g., times of arrival or (Doppler) frequency shifts) of the same MODE-S signal (or radio signal in general) are required. However, a higher number of observations (if available) can be used to improve the accuracy of the position determination and/or resolve the dilution of precision caused by the geometrical location of satellites with respect to the target aircraft.

Based on these at least four independent observations, the aircraft position can be mathematically derived as the intersection of at least three 2D-surfaces in 3D space (e.g., hyperboloids for TDOA-based techniques) with equations determined by the difference in the time of arrival (or frequency shift) of the radio signal at each of the satellites receiving it. Provided that all measurements are referred to the same system time reference (as described above), this will deliver the aircraft position, potentially with a residual error related to the time synchronization accuracy of all satellites involved in the specific measurement.

In other words, the position of the aircraft under consideration can be determined by using multilateration (multilateration techniques), based on the determined at least four times of arrival, or based on the determined at least four Doppler frequency shifts. Non-limiting examples of multilateration techniques are described in reference document [7] (for TDOA-based multilateration) and in reference document [8] (for FDOA-based multilateration). Using multilateration techniques for satellite-based air surveillance may additionally require knowledge of the (instantaneous) positions of the at least four satellites at respective times of arrival (for TDOA-based multilateration), or knowledge of the (instantaneous) velocity vectors of the at least four satellites at respective times of arrival (for FDOA-based multilateration).

Having the characteristics and properties described above, the proposed techniques according to the present disclosure permit going a step beyond existing surveillance solutions, which are notoriously based on the ADS-B signal content reporting the aircraft position from a GNSS on-board receiver. This is achieved by enabling also the acquisition and the use of other signals (e.g., MODE-S signals) for space-based surveillance without relying on any GNSS associated information. The proposed techniques automatically extend the range of aircraft that can be detected and tracked as, for instance, all aircraft in Europe are mandated to be equipped with MODE-S transponders while only a subset have to additionally carry ADS-B equipage.

Some embodiments of the present disclosure imply that captured signals will need to be further processed either on-board or on ground to extract an aircraft identifier (e.g., the 24-bit ICAO aircraft identifier that is uniquely associated to each aircraft). The aircraft identifier may be the only necessary information required by techniques according to these embodiments to determine the aircraft position, whereas additional information such as included in MODE-S extended squitter signals could optionally be used to further enhance performance (e.g., to enhance accuracy and reliability of signal detection and parameter estimation).

### System Overview

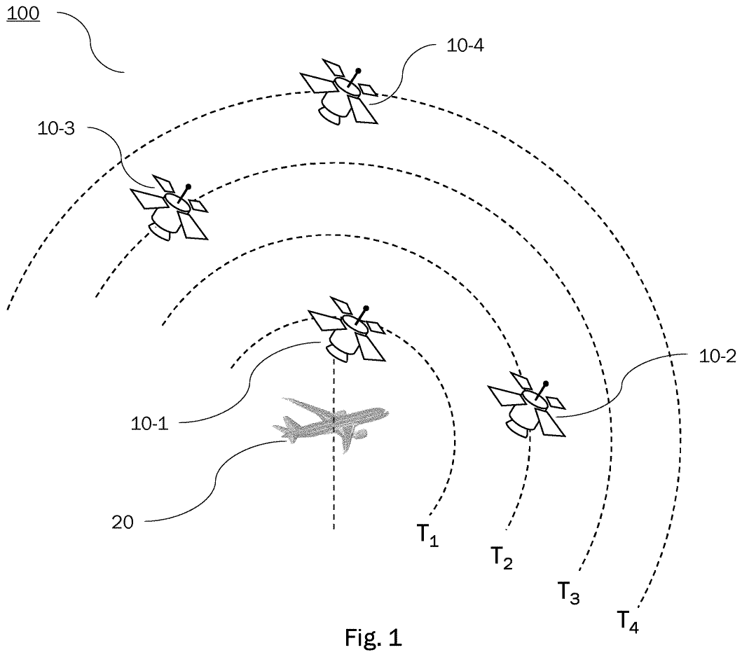

FIG. 1 shows an example of a conceptual implementation of techniques according to embodiments of the disclosure for air traffic surveillance. The system 100 for satellite-based air traffic surveillance shown in this figure comprises at least four satellites 10-1, . . . , 10-4 that (substantially) simultaneously and passively (e.g., without interrogation from the space segment) detect radio signals of predetermined format (broadcasting signals, e.g., MODE-S signals) transmitted by aircraft 20. Optionally, the system 100 may further comprise a ground segment with one or more data centers (not shown in this figure).

In general, systems for satellite-based air (traffic) surveillance for determining a position of an aircraft comprise at least four satellites in earth orbit. Each satellite may be configured to perform (at least part of) the processing of step S210 of method 200 described below. For example, each satellite may be configured for receiving the radio signal of predetermined format. Further, each satellite may be configured for determining a time of arrival and/or a Doppler frequency shift of the received radio signal at the respective satellite. Determining the time of arrival or the Doppler frequency shift of the received radio signal may comprise detecting a static portion of the received radio signal. Alternatively, the determining sub-step may be performed at a designated satellite or a ground station/data processing center, after raw signals as received have been forwarded to said designated satellite of ground station/data processing center. The systems further comprise a processing unit configured for performing step S220 of method 200 described below. For example, the processing unit may be configured for determining the position of the aircraft based on the determined at least four times of arrival or the determined at least four Doppler frequency shifts. This processing unit may be provided at one of the at least four satellites or separate from the at least four satellites. For example, the processing unit may be provided at the ground segment (e.g., ground station or data processing center) or at another, designated, satellite.

The aircraft 20 is understood to repeatedly (e.g., periodically) transmit the radio signal of predetermined format, for example via an upwards-pointing (or in some cases downwards-pointing, or both) antenna(s). It is further understood that the aircraft 20 transmits the radio signal of predetermined format regardless of interrogation by the system 100. For example, the radio signal may be a squitter signal in broadcast mode (e.g., MODE-S squitter), without need for interrogation. It is also possible to receive and analyze radio signals whose transmission is triggered by interrogation from other sources or entities that are independent from the air surveillance system 100 (i.e., third parties external to the system). In this sense, the proposed air traffic surveillance system is to be understood as a passive listener to signal traffic generated by aircraft in the area of coverage.

Techniques according to embodiments of the disclosure use a-priori knowledge of content (e.g., ICAO 24 bit aircraft identifier) of the radio signal (e.g., MODE-S signal) to detect the radio signal, the time of arrival, and/or the carrier frequency offset that represent the frequency Doppler. The known content may generally relate to static portions of the radio signal, i.e., portions of the radio signal that do not change from one transmission instance to the next.

Estimated parameters (e.g., (accurate) time of arrival and/or frequency Doppler shift) from multiple observing satellites may be used either on-board of one of the satellites (or a designated satellite other than the at least four satellites) or on-ground to determine the position of the aircraft (at the time of emitting the respective radio signal). This process may be repeated for each radio signal that is detected by multiple (e.g., at least four) satellites, to maintain recurrent tracking of the aircraft.

Techniques according to embodiments of the present disclosure facilitate the implementation of an inherently reliable system for air surveillance by leveraging the multiplicity of satellites that cooperate to compute the aircraft position. With appropriate design, such architecture permits avoiding single points of failure, including the space segment.

Protective measures may be implemented to guarantee security at all levels, including the satellite payloads, ground stations, and ground operation centers. The proposed techniques can facilitate a higher level of security for aircraft positioning, since the actual aircraft position is not determined by a single satellite only. Instead, the aircraft position is determined based on post-processing of multiple observations from multiple (e.g., at least four) satellites.

### Signal Source and Aero Segment

In the context of the present disclosure, the aero segment may refer to the ever-growing global fleet of aircraft equipped with signal transponders (e.g., MODE-S transponders) using top-mounted and/or bottom-mounted transmitting antennas, depending on which antenna allows for direct visibility of the aircraft from space. Without intended limitation, recurrent transmission of the MODE-S squitter (and extended squitter) broadcasting messages may be a primary signal source for use by the proposed techniques for tracking the position of aircraft.

In particular, the frequency band 1 087.7-1 092.3 MHz has been allocated by the ITU to the aeronautical mobile-satellite service (Earth-to-space) on a primary basis since 2015. Space-based detection of the MODE-S signals as presently proposed does not require any change or modification of the aero segment.

### Space Segment

The proposed techniques require detecting the same MODE-S broadcasting signal by at least four distinct satellite receivers. The time of arrival and/or an indication of the carrier frequency (e.g., frequency shift with respect to a reference frequency) of each message is communicated to the ground segment along with essential information such as an aircraft identifier (e.g., aircraft ICAO address) for multilateration processing. Alternatively, this information may be communicated to a satellite (e.g., one of the at least four satellites) for multilateration processing.

The space segment may consist of several sub-systems, as will be described next.

### On-Board Receiver Payload

The on-board receiver (e.g., MODE-S receiver) will reliably detect and decode the essential content of radio/broadcast signals (e.g., MODE-S extended squitter messages) received from the aircraft. Messages are time stamped (by using system time reference, preferably generated independently from GNSS) and optionally accompanied by essential metadata for delivery to a processing unit (e.g., ground segment or satellite) for post-processing. The on-board receiver may have the capability to concurrently detect and decode inputs from a multi-beam receiver antenna.

### Receiver Antenna Subsystem

The on-board receiver antenna sub-system will receive radio/broadcast signals (e.g., MODE-S signals) from any aircraft in the field of view. Due to the uncoordinated nature of signal broadcasting (e.g., MODE-S signal broadcasting), multiple signals may arrive at the antenna simultaneously (or at least partially colliding/overlapping). Optional use of multi-beam antennas allows to discriminate among messages arriving from different directions or sectors, hence enhancing the signal detection capability.

### End-to-End Communication Sub-System

Detected radio/broadcast messages (e.g., MODE-S messages) and their associated metadata must be delivered for post-processing (e.g., to the ground segment or a (designated) satellite) in a timely manner. The end-to-end communication may include inter-satellite links and/or satellite data relay solutions to facilitate the data delivery from each satellite to the ground segment or the designated satellite.

### Timing Synchronization and Orbit Determination Sub-System

The proposed methods and systems rely on an accurate system time reference (e.g., internally generated, for example independently from GNSS) shared among all space segment and, if applicable, ground segment assets. They may further require accurate orbital position of each spacecraft at the time of message (e.g., MODE-S message) detection. The time reference and orbit determination sub-systems will provide accurate and reliable information to ensure the desired end-to-end performance can be achieved. Implementation examples of such sub-systems are known to the skilled person.

### Ground Interface to Space Segment

As part of the end-to-end communication sub-system, the ground interface to space segment may comprise ground stations (either a service or as designated asset) to facilitate a secure, reliable, and timely delivery of detected messages from on-board receivers (e.g., MODE-S receivers) to the ground segment for further processing. In some implementations however, further processing for position determination may be performed at a satellite (e.g., designated satellite) that may or may not be among the satellites that have detected the radio signal from the aircraft.

### Data Processing Center

The data processing center may receive the necessary information for carrying out the multilateration processing. For example, the data processing center may receive (part of) the (relayed) MODE-S messages and associated metadata (e.g., time-stamps, indications of frequency shift, spacecraft positions at the time of message detection, etc.). The data processing center may carry out the multilateration processing and may interface with the end-users operations (e.g., Air Navigation Service Providers (ANSPs)). However, as noted above, further processing for position determination may also be performed at a (designated) satellite that may or may not be among the satellites that have detected the radio signal from the aircraft. It is understood that the relationship between the system time reference and an external user time reference (e.g., time reference used by the end-user operations) need to be known to correlate the determined aircraft position with the external user time reference.

### Description of Methods According to the Present Disclosure

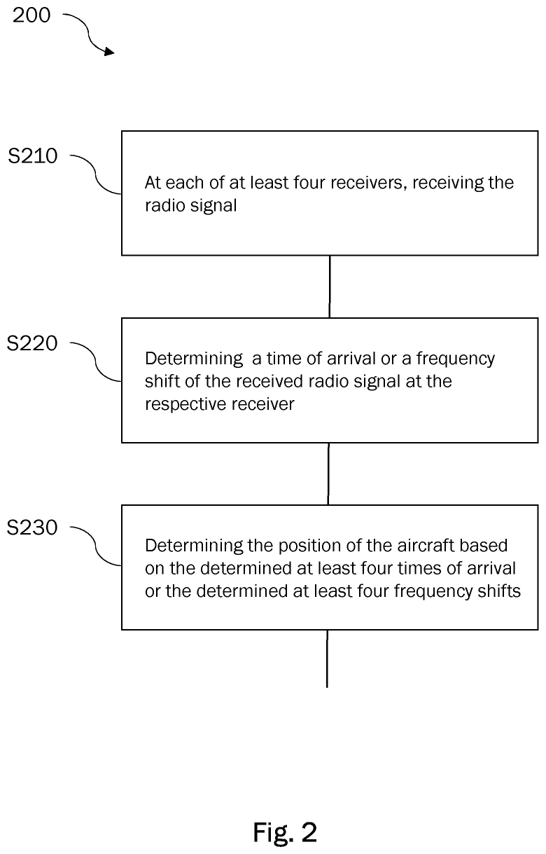

FIG. 2 is a flowchart illustrating an example of a method 200 of satellite-based air (traffic) surveillance for determining a position of an (airborne) aircraft according to embodiments of the disclosure. This method may be implemented, for example, by the system illustrated in FIG. 1, which comprises at least four satellites 10-1, . . . , 10-4 as part of the space segment. Method 200 comprises steps S210 and S220, of which (at least part of) step S210 may be performed for example by the satellites of the space segment, whereas step S220 may be performed by (a data processing center of) the ground segment, or by a designated satellite (e.g., among the at least four satellites or different from the at least four satellites that receive the radio signal).

It is understood that the aircraft repeatedly (e.g., periodically) transmits a radio signal of predetermined format. It is understood that the radio signal is transmitted so as to enable reception by spacecraft in earth orbit. As will be explained in more detail below, one example of this radio signal of predetermined format may be a MODE-S signal as defined according to the ICAO Specifications, as given for example in reference document [5]. A minimum requirement for the radio signal of predefined format however is that it includes a static portion that does not change from one transmission to the next. In some implementations, the static portion of the radio signal comprises a unique identifier of the aircraft, such as the aircraft's 24-bit ICAO identifier, for example. Optionally, the static portion may further comprise a fixed (and therefore known) preamble of the radio signal of predetermined format. For MODES-S, the static portion may comprise at least one of a known preamble sequence, a known downlink format, a known ICAO identifier, and a known transponder capability. Preferably, the static portion comprises at least the ICAO identifier (contained for example in symbol positions 9 to 32 of the MODE-S signal structure).

It is understood that the proposed method does not include interrogating the aircraft. For example, the radio signal of predetermined format may be a squitter signal in a broadcast mode that is (repeatedly) transmitted without any need of interrogation. It is also understood that the proposed method may use radio signals that are transmitted by the aircraft in response to interrogation that is independent from the proposed method (e.g., interrogation by another entity (third party) that is not under control of the proposed air surveillance system).

At step S210, at each of at least four satellites in earth orbit, the radio signal is received. Further, a time of arrival and/or a frequency shift (e.g., Doppler frequency shift) of the received radio signal at the respective satellite is determined (e.g., measured). This may be done either at the satellite itself, or, if a raw capture/version of the signal is forwarded to another entity (e.g., ground segment or designated satellite), at the other entity. Therein, determining the time of arrival or the frequency shift of the received radio signal comprises detecting the static portion of the received radio signal. Detecting the (known) static portion of the radio signal may enable (more accurate) estimation of signal parameters including the time of arrival (e.g., with reference to the common system time reference) and the frequency of the received signal. The latter may be compared to the known frequency of the radio signal or a local reference frequency of the receiver to determine the frequency shift. For example, the frequency shift may be determined with reference to the local reference frequency of the respective satellite, assuming that this local reference frequency is known or under control. It is understood that each receiver should give the frequency shift using the same reference frequency, and/or that the local reference frequencies are synchronized.

It is understood that step S210 involves determination of the times of arrival at the at least four satellites (e.g., times of arrival of the signals detected at the at least four satellites), and/or determination of the frequency shifts (e.g., Doppler frequency shifts) at the at least four satellites (e.g., frequency shifts of the signals detected at the at least four satellites), to thereby enable meaningful position determination. In other words, it is understood that at least four distinct times of arrival are determined and/or at least four distinct frequency shifts are determined.

It is further understood that determining the time of arrival and/or Doppler frequency shift involves well-known techniques for parameter estimation of a received radio signal. In embodiments of the present disclosure however, this estimation may be data-aided by relying on the (known) static portion of the radio signal. Examples of techniques for (data-aided) parameter estimation of a received radio signal are described for example in reference document [9].

In particular, detecting the static portion of the received radio signal by (or at) one or more (e.g., all) of the at least four satellites (e.g., in the process of parameter estimation) may comprise applying a correlator for the static portion to the received radio signal. Noting that the static portion is known, the correlator may be pre-established. Further, the correlator may be applied in response to detecting a predetermined preamble of the radio signal. For example, when receiving the radio signal and detecting the preamble, the correlator may be applied to a certain time window subsequent to the detected preamble.

The above may require that the static portion of the radio signal, in particular, the unique identifier of the aircraft, is known to the satellites receiving the radio signal. Accordingly, information on the unique identifier of the aircraft may be received by the at least four satellites as an input. When the aircraft to be tracked is known this will result in a shorter processing time. Alternatively, the unique identifier associated with an aircraft may be maintained and used from previously received instances of the radio signal of the same aircraft.

In the former case, the aircraft to be surveilled/tracked may be known in advance. In this case a correlator may be used to detect the specific 24-bit combination, for example triggered by detection of the preamble.

The latter case may relate to the surveillance system initially determining unique identifiers of aircraft that are within a certain area of coverage. For some implementations, this may involve, as part of detecting the static portion of the received radio signal by one or more of the at least four satellites, decoding the static portion of the received radio signal. Thereby, an overview over unique identifiers of aircraft in the area of coverage can be obtained. Then, in principle, each of these aircraft may be selected for tracking as the target aircraft of the proposed methods and systems.

In any case, it can be assumed that at least after an initial phase, the unique identifier of a particular aircraft to be tracked is known at the satellites.

Finally, for enabling multilateration of the aircrafts position, each of the at least four satellites may generate a data set (data record) including the determined time of arrival or Doppler frequency shift in association with the detected unique identifier of the aircraft. These data sets may be collected, possibly together with the satellites' orbit positions (and potentially, time derivatives thereof or other indications of satellite velocity) at respective times of arrival, at a given location for the determination of the position of the aircraft.

At step S220, the position of the aircraft is determined based on the determined (e.g., measured) at least four times of arrivals or the determined (e.g., measured) at least four frequency shifts (e.g., Doppler frequency shifts). Determination of the position of the aircraft may use differential techniques, and may be based, for example, on time differences between times arrival and/or frequency differences between (Doppler) frequency shifts. Both for the case of time differences of arrival and the case of frequency differences of (Doppler) frequency shifts, this may be done by using (differential) multilateration techniques. For example, the (at least) four times of arrival may be used for determining (e.g., calculating) (at least) three independent time differences of arrival, or the (at least) four (Doppler) frequency shifts may be used for determining (e.g., calculating) (at least) three independent differential (Doppler) frequency shifts, to which multilateration techniques may then be applied.

For performing multilateration based on the at least four times of arrival, the positions of the satellites at the relevant points in time (e.g., at respective times of arrival) need to be known or derivable. For example, the positions can be derived from the satellites' known orbits. That is, each satellite's position may be derived based on the satellite's known orbit (as a function of time) and the respective time of arrival as determined at step S210. For performing multilateration based on the at least four Doppler frequency shifts, the velocities (e.g., velocity vectors) of the satellites at the relevant points in time (e.g., at respective times of arrival) need to be known or derivable. For example, the velocities (e.g., velocity vectors) can be derived from the satellite's known orbits by taking time derivatives thereof. Accordingly, also each satellite's velocity (e.g., velocity vector) may be derived based on the satellite's known orbit (as a function of time) and the respective time of arrival as determined at step S210.

### MODE-S Signal Structure

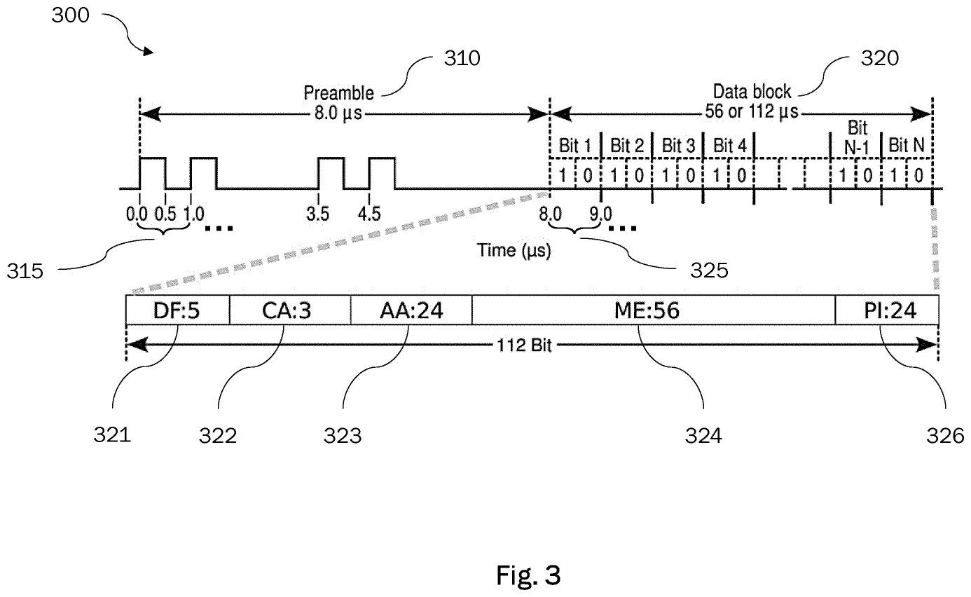

As noted above, a preferred (although not exclusive) implementation of the radio signal of predefined format is the MODE-S signal, as defined in reference document [5]. FIG. 3 shows an example of the MODE-S(extended) squitter signal structure (MODE-S(extended) squitter format).

As shown in this figure, a transmitted MODE-S signal 300 comprises a preamble 310 of 8.0 μs duration (corresponding to 8 symbols 315 of 1 μs duration each), followed by a data block 320 of 56 μs duration (MODE-S squitter format) or 112 μs duration (MODE-S extended squitter format). The data block 56 is transmitted as pulse position modulation (PPM). This means that for every time slot 325 of 1 μs duration, a bit is indicated by either sending a 0.5 μs pulse in the first half of the slot (1-bit, or bit state “1”) or in the second half (0-bit, or bit state “0”).

While reference is made to PPM as modulation scheme for MODE-S, it is understood that alternative modulation schemes, such as for example Phase Shift Keying (PSK) may be used as well. Importantly, the radio signal has a plurality of consecutive symbols (or bit positions) that carry their prescribed information.

MODES-S allows for two possible data block sizes of either 56 bits (for the MODE-S signal) and 112 bits for the extended MODES-S signal. A standard MODE-S signal (e.g., MODE-S acquisition squitter signal) carries static information that corresponds to the ICAO address (AA field 323). The 56-bit data block 320 in this case further comprises a 5-bit downlink format field (DF field 321), a 3-bit transponder capability field (CA field 322), and a 24-bit parity field (PI filed 326).

The 24-bit parity bits (PI field 326) may comprise the ID of the integrator RADAR overlaid on top of the parity bits. However, for MODE-S squitter broadcasting that is not in reply to a particular interrogator, there is no overlay signal on top of the parity bits.

In case the first 8 bits of information in front of the ICAO address (i.e., downlink format and transponder capability) is also static, the entire content of the MODE-S signal could be known to the receiver. In this case, the entire MODE-S signal squitter signal carries static bits (corresponding to the aircraft ID and associated parity bits). The proposed techniques may rely on any of these data fields as the static portion for detection (e.g., at step S210 of method 200). Preferably, this includes at least the 24-bit ICAO address (e.g., at bit positions 9 through 32 of the MODE-S signal).

In other words, the static portion of the MODE-S signal comprises at least one of a known preamble sequence, a known downlink format, a known ICAO identifier, and a known transponder capability. In general, the static portion may include any parts of the underlying message that are static and/or known at the receiver.

For the MODE-S extended signal, the data block 320 further comprises a 56-bit message field (ME field 324) as described below.

Table 1 shows the data structure of the MODE-S(extended) signal. A header consisting of 8 bits allows to define a multi-purpose format. The header consists of the 5-bit downlink format (DF) field 321 and 3 bits of transponder capability (CA field 322). The 8 bit header is followed by the 24 bits of the ICAO aircraft address 323. Additional 56 bits exist in MODE-S extended squitter (ME field 324) that could carry different types of information, such as aircraft attitude, velocity and position (ADS-B) or flight information, for example. These are defined as part of the type code bits (the first three bits of the 56-bit message). The use of extended squitter may be recognized based on the downlink format as shown in Table 2. In particular, downlink format DF=11 is used for MODE-S squitter (broadcast) and downlink format DF=17, 18 are used for extended squitter.

Analyzing the 24 bits (parity bits) of PI field 326, it is possible for recipients to correct up to 5 bit errors in 1090 extended squitter(ES) messages using a fixed generator polynomial of degree 24. This capability can be used to check and verify the correct signal content.

TABLE 1
MODE-S (Extended) Data Structure

| | | | Bit location | |
|---|---|---|---|---|
| | | | with the | |
| | | Number | MODE-S | |
| Data Content | Abbreviation | of bits | structure | Remarks |
| Downlink Format | DF | 5 | 1-5 | |
| Transponder | CA | 3 | 6-8 | |
| Capability | | | | |
| ICAO Aircraft Address | ICAO | 24 | 9-32 | |
| Message | ME | (56) | (33-88) | Only Applicable to Extended |
| (Extended Squitter) | | | | Squitter |
| Parity/Interrogator ID | PI | 24 | 33-56 | MODE-S Acquisition |
| | | | (89-112) | (MODE-S Extended) |

TABLE 2
Examples of Downlink Format Mapping

| DF | | Number of |
|---|---|---|
| format ID | Downlink Type | MODE-S bits |
| 0 | Short air-air Surveillance (ACAS) | 56 |
| 11 | MODE-S All-Call Reply | 56 |
| 16 | Long air-air surveillance (ACAS) | 112 |
| 17 | Extended Squitter | 112 |
| 18 | Extended Squitter/non-transponder | 112 |
| 19 | Military Extended Squitter | 112 |
| 20 | Altitude Reply | 112 |
| 21 | Identity Reply | 112 |

### MODE-S Signal Detection and Parameter Estimation

As described above, one key difference between techniques according to the present disclosure and conventional air traffic surveillance techniques is to use the MODE-S signal independently of the aircraft self-position reporting content (e.g., ADS-B message content) to determine the aircraft geolocation. For this purpose, it is proposed to use MODE-S squitter broadcast signals (e.g., corresponding to DF=11, 17, 18) and to take advantage of known content of these messages to detect the presence of the radio signal at the receiver and to estimate the relevant parameters, such as the time of arrival and/or the frequency Doppler associated with the received radio signal.

The MODE-S squitter signal carries the ICAO aircraft address (as an example of a unique aircraft identifier) followed by parity bits. Since the signal is sent in broadcast mode it does not contain any reply to interrogators overlaid on the parity bits. Therefore the entire content of the signal is static and repeated at a given rate, for example 1 per second.

In case of DF=11 (MODE-S acquisition squitter), the length of known symbols will be increased from 8 known PPM symbols (corresponding to 8 μsec) to 64 symbols (corresponding to 64 μsec). This will result in a significant improvement in the probability of detection as well as the accuracy of the timing estimation and carrier frequency estimation.

### A-Priori Knowledge of the ICAO Address and Aircraft Identification

The knowledge regarding the ICAO address of the aircraft can be collected and provided to the satellite spacecraft individually via communication links for example from the ground segment (e.g., from ground data center(s)) according to the satellite footprint at different orbital positions. This information can be provided according to the scheduled flights from active flight routes considering the starting and destination airports. Accordingly, ICAO addresses of aircraft (expected to be) in the area of coverage of the proposed techniques may be assumed to be known.

In addition, each satellite MODE-S receiver can maintain a log of correctly detected MODE-S signals and extract the ICAO address from those messages for the detection and parameter estimation of subsequent MODE-S broadcast messages from the aircraft as received on-board of the satellite.

The list of actively tracked ICAO addresses by each spacecraft may be updated continuously to reduce the computational load. Further, this list may be shared with other satellites of the system.

In case of capturing the raw in-phase and quadrature samples to be delivered on ground (or to a designated satellite) for post-processing, the ICAO addresses may be provided to the ground segment (or the designated satellite) for MODE-S signal processing.

### Geo-Localization

The estimated times of arrival as well as the carrier Doppler estimations may be collected from multiple satellites for each received MODE-S signal and corresponding ICAO address.

The ground segment (e.g., a data processing center) or designated satellites may receive MODE-S messages and associated metadata (e.g., time-stamps, spacecraft positions at the time of message detection) and may carry out the multilateration processing, as described above.

As another example of the proposed methods and systems, the data raw samples or radio frequency signals may be directly captured and transferred to another (designated) satellite or the ground segment for centralized processing. In this example, the MODE-S signal processing of signals from multiple satellites may be performed centrally, allowing to use more resources available on ground or on-board.

The ground segment (e.g., data processing center) may interface with the end-users operation (e.g. ANSPs).

### Technical Results

Next, examples of technical results of applying techniques according to embodiments of the disclosure will be described.

### Link Characteristics

Table 3 below provides examples of key parameters relevant to the link budget for MODE-S signals at the transmitter (e.g., aircraft).

TABLE 3
Aircraft-Satellite MODE-S Link Characteristics

| Parameter | unit | Value | Comment | |
|---|---|---|---|---|
| Aircraft Tx Power | W | 125 | Class A1/A2 aircraft. Value could | |
| | | | be higher for Class A3 | |
| Centre Frequency | MHz | 1090 | | |
| Frequency uncertainty | MHz | ±1 | | |
| Tx Antenna Polarization | | Vertical | | |
| Tx Antenna gain | dBi | Variable | Typical example of the top mounted | |
| | | | antenna of a cruising aircraft: | |
| | | | Elevation | |
| | | | (degrees) | Tx Antenna gain |
| | | | 0 | 1.6 dBi |
| | | | 5 | 2.5 dBi |
| | | | 10 | 3.1 dBi |
| | | | 15 | 3.6 dBi |
| | | | 20 | 3.9 dBi |
| | | | 25 | 4.1 dBi |
| | | | 30 | 4.0 dBi |
| | | | 35 | 3.8 dBi |
| | | | 40 | 3.4 dBi |
| | | | 45 | 2.8 dBi |
| | | | 50 | 2.0 dBi |
| | | | 55 | 1.1 dBi |
| | | | 60 | 0.0 dBi |
| | | | 65 | 1.3 dBi |
| | | | 70 | 2.8 dBi |
| | | | 75 | −4.4 dBi |
| | | | 80 | −6.2 dBi |
| | | | 85 | −8.2 dBi |
| | | | 90 | −10.4 dBi |
| Required Spectrum Limits | MHz | ±1.3 | Around the Carrier Centre Frequency | |
| according to ICAO | | ±7 | | |
| reference document [5] | | ±23 | | |
| 3 dB Mask | | ±78 | | |
| 20 dB Mask | | | | |
| 40 dB Mask | | | | |
| 60 dB Mask | | | | |

| | | | |
|---|---|---|---|
| Message Length | μsec | 120 | Extended Squitter, including the preamble |
| | | 64 | MODE-S Acquisition Squitter, including |
| | | | the preamble |

For space-based MODE-S receivers, the link budget characteristics may also depend on the satellite orbit as well as the receiver sensitivity and antenna gain. As a practical example, Table 4 provides a summary of the link budget for a satellite in Low Earth Orbit (LEO) that observes the MODE-S signal. As shown, at a low elevation angle (i.e., for a majority of aircraft within the satellite's visibility) the signal to noise ratio (SNR) is comparatively low. This will lead to more stringent requirements for a high gain Rx antenna on-board of the satellite. The use of the proposed detection techniques based on the static portion of the MODE-S signal (e.g., the entire MODE-S signal in some cases) allows to operate at lower signal to noise ratio, which can relax the high antenna gain requirement for the spacecraft.

TABLE 4
Example of Link Budget Analyses for a LEO 780 km orbit
satellite and a beam pointing at 50.5 deg off-nadir Angle

| Parameter | unit | Value | | | | | |
|---|---|---|---|---|---|---|---|
| Satellite Altitude | km | 780 | | | | | |
| Elevation Angle | deg | 5 | 10 | 30 | 40 | 60 | 80 |
| Off-Nadir Look Angle | deg | 62.6 | 61.3 | 50.5 | 43.0 | 26.5 | 8.9 |
| Slant Range | km | 2742.8 | 2327.4 | 1365.4 | 1132.9 | 886.0 | 791.7 |
| Aircraft Tx Power | W | 125 | | | | | |
| Aircraft Tx Antenna Gain | dBi | 2.5 | 3.1 | 4.0 | 3.4 | 0.0 | −6.2 |
| Aircraft EIRP | dBW | 23.5 | 24.1 | 25.0 | 24.4 | 21.0 | 14.8 |
| Free Space Loss | dB | 162.0 | 160.5 | 155.9 | 154.3 | 152.1 | 151.2 |
| Atmospheric loss | dB | 1.9 | 1.1 | 0.7 | 0.5 | 0.5 | 0.5 |
| Loss-Polarization | dB | 3 | | | | | |
| Satellite Rx Antenna | dBi | 10 | 11.5 | 12 | 11.5 | 9.5 | 6.0 |
| Gain | | | | | | | |
| Receiver System Noise | K | 500 | 500 | 500 | 500 | 500 | 500 |
| Temperature | | | | | | | |
| Satellite G/T | dB/K | −17.0 | −15.5 | −15.0 | −15.5 | −17.5 | −21.0 |
| (Noise) Bandwidth | MHz | 2.0 | | | | | |
| C/N | dB | 5.2 | 9.6 | 16.0 | 16.7 | 13.5 | 4.7 |

### MODE-S Signal Detection Performance

For known signal detection algorithms with constant false-alarm properties, by increasing the length of known symbols from 8 symbols (e.g., conventional MODE-S preamble length) to 64 symbols (by using the entire MODE-S signal content) there is a significant improvement in reducing the probability of false alarm as well as probability of miss detection.

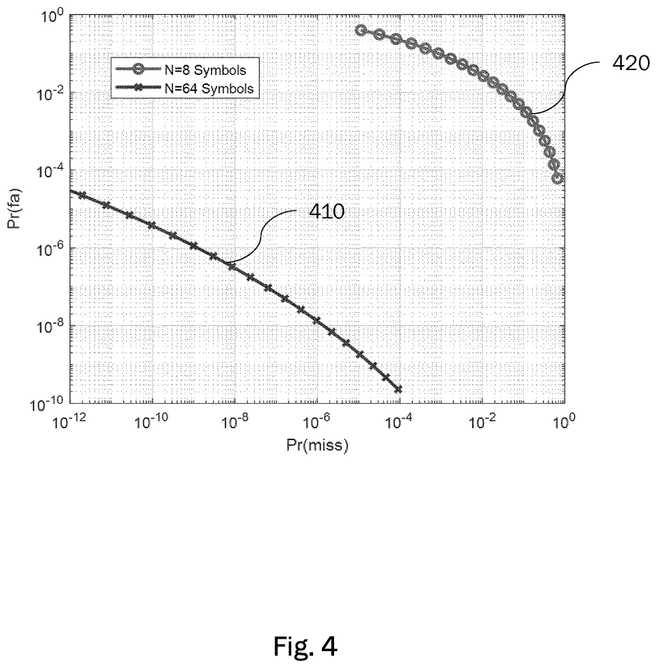

Examples of corresponding analysis results for a system operating at 3 dB SNR and in the presence of 0.5% normalized carrier frequency offset are shown in FIG. 4. The horizontal axis of this diagram relates to a miss-detection probability Pr(miss) and the vertical axis relates to a false alarm probability Pr(fa). Graph 410 shows the relationship between the aforementioned probabilities for N=64 symbols, whereas graph 420 shows the relationship for N=8 symbols (i.e., preamble only). As can be seen, the reliability of MODE-S signal detection can be improved by several orders of magnitude when considering known signal content beyond the 8-symbol preamble.

### Timing Estimation

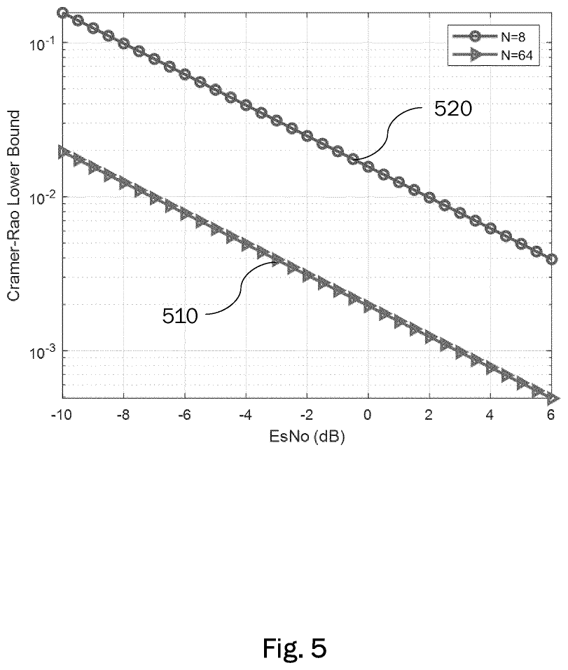

FIG. 5 illustrates an example of the impact of the preamble length (or the length of the known signal portion in general) on the accuracy of the timing estimate. The accuracy may be measured in terms of the lower theoretical bound on the variance of the timing estimator that is known as the Cramer-Rao lower bound. The horizontal axis of this diagram relates to the SNR or Es/No (in units of dB) and the vertical axis relate to the Cramer-Rao bound. Graph 510 shows the relationship between the aforementioned quantities for N=64 symbols, whereas graph 520 shows the relationship for N=8 symbols (i.e., standard-size preamble only). As can be seen, by increasing the length of the known symbols (e.g., preamble) from 8 symbols to 64 symbols (e.g., the entire length of the MODE-S signal), the required SNR for the same variance can be reduced by up to 8 dB in this example.

### Carrier Frequency Estimation

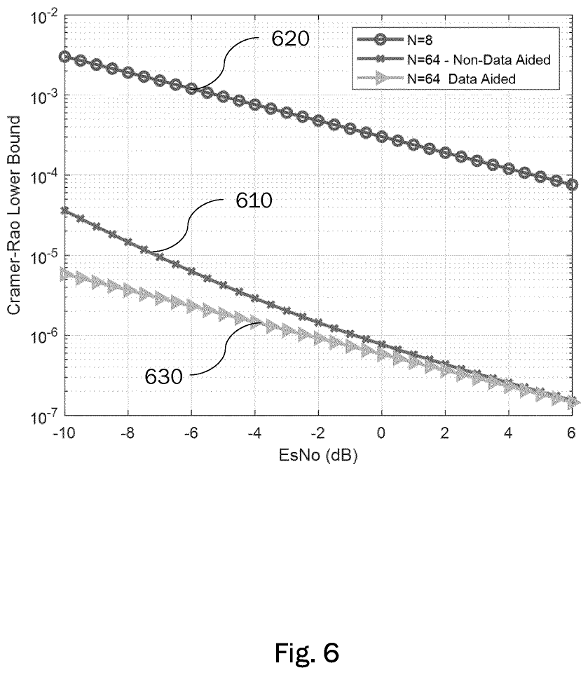

FIG. 6 shows an example of the Cramer-Rao lower bound of the carrier frequency offset estimator based on 8 known symbols preamble vs. 64 known symbols (data aided) as well as 64 unknown binary symbols (non-data aided). The horizontal axis of this diagram relates to the SNR or Es/No (in units of dB) and the vertical axis relate to the Cramer-Rao bound. Graphs 610 and 630 show the relationship between the aforementioned quantities for N=64 symbols in a non-data aided scenario and a data aided scenario, respectively, whereas graph 620 shows same relationship for N=8 symbols. As can be seen, use of 64 known symbols offers a significant improvement in the variance of the estimator compared to that of using only 8 symbols (e.g., preamble only). Compared to the non-data aided estimator, the gain of the data-aided estimator is more noticeable at very low SNRs.

### SUMMARY

The proposed methods and systems for satellite-based air traffic surveillance may have the following characteristics:

1) The proposed methods and systems may determine the position of an aircraft broadcasting a MODE-S signal containing the unique aircraft ICAO identifier. Such methods and systems may be completely independent of GNSS, as they are established through internal system non-GNSS-depended reference time.

2) The proposed methods and systems may obtain (e.g., determine) the aircraft position through utilization of times of arrival or frequency offsets associated with the reception of the given instance of a MODE-S signal that is broadcast by the aircraft and that is subsequently received by four or more satellites. Reception by the four or more satellites may be during a predefined time interval (e.g., corresponding to a maximum possible time difference for reception, based on relative distances between the satellites).

3) Signal detection and parameter estimation of MODE-S signals may be enhanced by using a-priori knowledge (e.g., via the aircraft ICAO identifier) relating to the content of the MODE-S signal(s). Known content may be static content, for example.

4) MODE-S radio signal detection may be further enhanced by using knowledge of known (e.g., static) content of the MODE-S squitter or extended squitter radio signal.

5) The proposed methods and systems foresee to provide MODE-S signal content to a respective on-board payload receiver aboard each satellite to assist the detection and parameter estimation of the MODE-S signal received from the (same) aircraft. The knowledge of the ICAO address could be provided from a data center via a communication link or it could be extracted from MODE-S signals already detected at the satellites.

6) Some implementations of the proposed methods and systems may foresee to collect raw captures of the MODE-S signals from multiple observations onboard of satellites and perform analyses on a different (designated) satellite or transfer to ground for MODE-S signal detection and accurate time and frequency estimation.

7) The proposed methods and systems further may foresee enhancing parameter estimation (time and/or frequency) from multiple satellites to determine the position of the aircraft using a-priori known symbols of the MODE-S message to detect presence of the MODE-S message and to estimate the time of message arrival and/or the carrier frequency offset.

8) The proposed methods and systems further may foresee use of inter-satellite links and/or a combination of direct links to ground to establish a common system time reference, independent of the GNSS.

The proposed space-based methods and systems for air traffic surveillance may bring benefits in terms of cost efficiency, spectrum efficiency, ease of service deployment, and/or potential for worldwide operation:
cost effective surveillance by relying solely on already existing aircraft equipage (e.g., on-board MODE-S transponders) with no additional costs for airspace users (e.g., airlines, etc.).
spectrum friendly operation in the aeronautical frequency band, since the proposed techniques relate to passive systems that can operate with zero interference in the aeronautical frequency band.
leverage of proven ground-based multilateration techniques that can deliver a robust surveillance solution as needed when dealing with safety-of-life services.
GNSS independence, which significantly increases robustness of air traffic surveillance.
harmonized surveillance service provision through a single satellite-based infrastructure, shortening service deployment times, and simplifying surveillance data sharing among states.
potential for a worldwide service.

It is understood that any modules, units, or blocks described above may be implemented by a computer processor or respective computer processors, or the like. Modules, units, or blocks described above may further be implemented in a cloud-based manner.

It should further be noted that the description and drawings merely illustrate the principles of the proposed method and system. Those skilled in the art will be able to implement various arrangements that, although not explicitly described or shown herein, embody the principles of the present disclosure and are included within its spirit and scope. Furthermore, all examples and embodiment outlined in the present document are principally intended expressly to be only for explanatory purposes to help the reader in understanding the principles of the proposed method and system. Furthermore, all statements herein providing principles, aspects, and embodiments of the disclosure, as well as specific examples thereof, are intended to encompass equivalents thereof.

Thus, the various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

### REFERENCE DOCUMENTS

[1] K. Werner, J. Bredemeyer, T. Delovski, “ADS-B over Satellite-Global Air Traffic Surveillance from Space” 2014 Tyrrhenian International Workshop on Digital Communications-Enhanced Surveillance of Aircraft and Vehicles (TIWDC/ESAV)
[2] U.S. Pat. No. 10,901,093 B3, “Position Validation”, Aireon LLC, 26 Jan. 2021
[3] John Dolan, “AIREON INDEPENDENT VALIDATION OF AIRCRAFT POSITION VIA SPACE-BASED ADS-B”, 2018 Enhanced Solutions for Aircraft and Vehicle Surveillance (ESAVS) Applications Conference.
[4] US 2007/252760 A1, “Methods and Apparatus for ADS-B validation, Active and Passive Multilateration”, and Elliptical Surveillance
[5] Annex 10 to the Convention on International Civil Aviation, Volume IV, 5th Edition 2022: Aeronautical Telecommunications, Volume IV, Surveillance and collision Avoidance Systems,
[6] U.S. Pat. No. 6,633,590 B1 “Method of Synchronizing a Reference clock of a Ground Station and a Clock of a Remote System”, Garofalo et al.
[7] David Munoz, Frantz Bouchereau Lara, Cesar Vargas, Rogerio Enriquez-Caldera, “Position Location Techniques and Applications”, Elsevier Science, May 2009, ISBN 13:978-0-12-374353-4
[8] Ho, K. C.; Chan, Y. T., “Geolocation of a known altitude object from TDOA and FDOA measurements,” IEEE Transactions on Aerospace and Electronic Systems, vol. 33, no. 3, pp. 770-783, July 1997
[9] Umberto Mengali and Aldo N. D'Andrea, “Synchronization Techniques for Digital Receivers,” Applications of Communications Theory, Springer Science & Business Media, 1997

1. A method of air-based or space-based air surveillance for determining a position of an aircraft, wherein the aircraft repeatedly transmits a radio signal of predetermined format, the method comprising:
at each of at least four airborne or spaceborne receivers, receiving the radio signal;
determining a time of arrival or a frequency shift of the received radio signal at the respective receiver, wherein determining the time of arrival or the Doppler frequency shift of the received radio signal comprises detecting a static portion of the received radio signal; and
determining the position of the aircraft based on the determined at least four times of arrival or the determined at least four Doppler frequency shifts.

2. The method according to claim 1, wherein the static portion of the radio signal comprises a unique identifier of the aircraft.

3. The method according to claim 1, wherein the static portion further comprises a fixed preamble of the radio signal of predetermined format.

4. The method according to claim 1, wherein the radio signal of predefined format is a MODE-S signal.

5. The method according to claim 4, wherein the static portion of the MODE-S signal comprises at least one of a known preamble sequence, a known downlink format, a known ICAO identifier, and a known transponder capability; and/or
wherein the static portion of the MODE-S signal comprises bit positions 9 through 32 of the MODE-S signal

6. (canceled)

7. The method according to claim 2, wherein information on the unique identifier of the aircraft is received by the at least four receivers as an input or is determined from analysis of previously received instances of the radio signal.

8. The method according to claim 1, wherein detecting the static portion of the received radio signal comprises applying a correlator for the static portion to the received radio signal; and
wherein the correlator is applied in response to detecting a predetermined preamble of the radio signal.

9. (canceled)

10. The method according to claim 1, wherein detecting the static portion of the received radio signal comprises decoding the static portion of the received radio signal.

11. The method according to claim 1, further comprising establishing a common time reference for the at least four receivers.

12. The method according to claim 11, wherein the common time reference for the at least four receivers is independent from a time reference of a transmitter of the radio signal; and/or
wherein the common time reference for the at least four receivers is independent from a GNSS time reference.

13. (canceled)

14. The method according to claim 1, wherein the position of the aircraft is determined based on the determined at least four times of arrival by using multilateration; or
wherein the position of the aircraft is determined based on the determined at least four frequency shifts by using multilateration.

15. (canceled)

16. The method according to claim 1, wherein the position of the aircraft is determined further based on known positions of the at least four receivers at respective times of arrival.

17. The method according to claim 2, further comprising, by each of the at least four receivers:
generating a data set including the determined time of arrival or frequency shift in association with the unique identifier of the aircraft.

18. The method according to claim 1, wherein the aircraft periodically transmits the radio signal of predetermined format; and/or
wherein the aircraft transmits the radio signal of predetermined format regardless of interrogation.

19. (canceled)

20. A system for air-based or space-based air surveillance for determining a position of an aircraft, wherein the aircraft repeatedly transmits a radio signal of predetermined format, the system comprising:
at least four airborne or spaceborne receivers, each receiver configured to receive the radio signal and determining a time of arrival or a frequency shift of the received radio signal at the respective receiver, wherein determining the time of arrival or the frequency shift of the received radio signal comprises detecting a static portion of the received radio signal; and
a processing unit configured to determine the position of the aircraft based on the determined at least four times of arrival or the determined at least four frequency shifts.

21. The system according to claim 20, wherein the static portion of the radio signal comprises a unique identifier of the aircraft.

22. The system according to claim 21, wherein the static portion further comprises a fixed preamble of the radio signal of predetermined format.

23. The system according to claim 20, wherein the radio signal of predefined format is a MODE-S signal.

24. The system according to claim 23, wherein the static portion of the MODE-S signal comprises at least one of a known preamble sequency, a known downlink format, a known ICAO identifier, and a known transponder capability; and/or
wherein the static portion of the MODE-S signal comprises bit positions 9 through 32 of the MODE-S signal.

25. (canceled)

26. The system according to claim 21, wherein information on the unique identifier of the aircraft is received by the at least four receivers as an input or is determined from analysis of previously received instances of the radio signal.

27-38. (canceled)
